(19) United States
(12) Patent Application Publication
(10) Pub. No.: US 2003/0205036 A1
(43) Pub. Date: Nov. 6, 2003

(54) Riding saddle ensemble and corresponding use

(76) Inventor: Jaume Ventura Sala, Sant Cugat del Valles (ES)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/427,142

(22) Filed: Apr. 30, 2003

(30) Foreign Application Priority Data
May 3, 2002 (ES) 200201006

(51) Int. Cl. B68C 1/04

(52) U.S. Cl. 54/44.3

(57) ABSTRACT

Riding saddle ensemble and corresponding use. The riding saddle ensemble comprises a metal tree, two pads (3) and a seat. The tree is made up of a structure of metal rods and comprises two warped bars (1) which are the same and symmetrical with respect to an intermediate plane, where each pad (3) is attached to one of the bars, and a front bridge (5) and a rear bridge (7) which extend in a curved manner between both bars (1). The riding saddle ensemble also comprises an anatomical platform (13), attached to the metal tree, which is rigid and is suitable for withstanding indefinitely the weight of a rider without becoming permanently deformed. Preferably a single piece of leather (21) is used to cover the whole of the top part of the platform (13).

### DESCRIPTION

1. Field of the Invention

The invention relates to a riding saddle ensemble, of the type comprising a metal tree, two pads and a seat, where the tree is made up of a structure of metal rods and comprises: [a] two warped bars that are the same and symmetrical to an intermediate plane, where each pad is attached to each bar, and [b] a front bridge and a rear bridge which extend in a curved manner between both bars. The seat is attached to the tree and directly supports the weight of the rider. The invention relates also to a use of a single piece of leather.

2. State of the Art

Riding saddle ensembles are known of the type indicated at the beginning. In particular, Spanish patent No. ES P9900252, applied for on Feb. 8, 1999 by the same applicant and which is incorporated herein for reference, describes a riding saddle ensemble of this type. Said patent ES P9900252 describes the use of a piece of leather that extends between the front bridge and the rear bridge and which supports the rider's body.

Nevertheless, this piece of leather has several drawbacks. On the one hand it is raised too high with respect to the horse's back. As a person skilled in the art knows, it is desirable that the distance between the horse and the rider be minimal (although they should not touch so as to allow the horse's back to transpire and to avoid friction and pressure on the horse's spine). Another drawback lies in the fact that the piece of leather is too resilient and causes a “spring effect” which makes the rider bounce too much in the seat. Also another drawback is that, through use, the piece of leather starts to give and gradually becomes deformed.

### SUMMARY OF THE INVENTION

The objective of the invention is to overcome these drawbacks. This aim is achieved by means of a riding saddle ensemble of the type indicated at the beginning characterised in that it comprises an anatomical platform, attached to the metal tree, this platform being rigid and suitable for indefinitely resisting the weight of a rider without becoming permanently deformed.

In fact, a rigid platform of this type prevents the rider from bouncing excessively in the saddle. In addition, its geometry can be less dependent on material requirements and more adapted to the rider's requirements. Therefore, in patent ES P9900252 the piece of leather described extends from the front bridge to the rear bridge following a substantially “rectilinear” (longitudinal) trajectory. There are two consequences to this: on the one hand the rider is too removed from the horse's back, particularly if he sits on the front part of the piece of leather. However, the anatomical platform can be attached to the front bridge and then fall away relatively suddenly so that the rider is much closer to the horse's back.

The concept of rigidity, as used in this specification, must be understood to mean that the platform maintains its shape without the need to be tensioned. In other words, rigidity must be understood in terms of inflexibility and not inelasticity. Flexible materials, such as cables, ropes, fabrics or organic materials, like leather, can be folded and remain more or less folded, and so they have to be secured at the ends with a certain amount of tension to maintain a particular shape. This causes a “spring effect” or “drum skin effect” which is uncomfortable for the rider.

Preferably the anatomical platform has a hollow space in the area corresponding to the rider's genitals. In fact, in the case of regular riders or riders who spend many consecutive hours in the saddle, this hollow space can avoid various medical problems in the genital area caused by friction, pressure and sweat.

Advantageously the riding saddle ensemble has at least one height adjustment device for at least one of the front or rear ends of the seat. Preferably it will have a height adjustment device for the rear end of the seat. As is known, the fact that the rider sits further forward or further backwards with respect to the horse's cross, can influence his control over the horse. On the one hand when the rider sits further forward he has more control over the horse, although the horse tires more easily. On the other hand, it the rider sits further towards the rear he has less control over the horse, but the horse does not tire as much. The rider can combine both types of control, adapting it according to the needs of the terrain and the type of manoeuvre he wishes to perform. By means of the height adjustment device according to the invention the geometry of the platform can be altered, by raising or lowering it at particular points, which moves the rider's position on the horse forwards or backwards.

A preferable embodiment of a height adjustment device consists in providing a screw that passes through a first hole in the platform and a second hole in the tree, and with a nut threaded onto the screw and which remains between the first and second hole. Another possibility of implementing the height adjustment device consists in providing a threaded screw in a threaded hole made in the tree and which is supported on the lower surface of the platform. Preferably the platform is also provided with first slots, arranged advantageously in the central part thereof and in the longitudinal direction, which correspond to second slots made in the tree. Some attachment means, for example threaded screws, can be provided in any position of said slots. In this way, varying the position of the attachment point alters the geometry of the platform whereby the lowest point on the top part of the platform (the part that is in contact with the rider) remains in a more forward or backward position depending on the position of the attachment point.

The platform will be advantageously covered with an ergonomic material on which the rider will rest. Preferably the top part of the platform, which is the part in contact with the rider's body, will be covered with a single part. In this way, the uniformity and softness of the surface in contact with the rider is guaranteed, as well as the rider's comfort.

When adjusting the height of the platform ends, the platform deforms to adapt to the new position. It is advantageous that the single part covering the top part of the platform deforms plastically and absorbs the geometrical changes produced by the height adjustment device. One material that is particularly suitable for covering the top part of the platform is leather. In fact, leather has the advantage that, when conveniently moistened or even simply with the weight of the rider's body, it can deform plastically and adapt to the new geometry. However, it is particularly important that the piece of leather covering this top part of the platform be a single part. In this way it will be able to adapt to any platform geometry without producing any folds or breakages, which would occur if the piece of leather had seams, since seams are not plastically adaptable.

The objective of the invention is the use preferably of a single piece of leather to cover the whole of the top part of a platform in accordance with the invention. Leather-covered saddles are known, but the piece of material covering the seat is made up of several pieces of leather, which is easier for production. However, as described above, it is of particularly interest that the covering be made from one single piece of leather.

### BRIEF DESCRIPTION OF THE DRAWINGS

Other advantages and features of the invention can be appreciated from the following, non-limiting description of a preferred embodiment of the invention, with reference to the accompanying drawings, in which:

FIG. 1 is a plan view of a tree according to the invention.

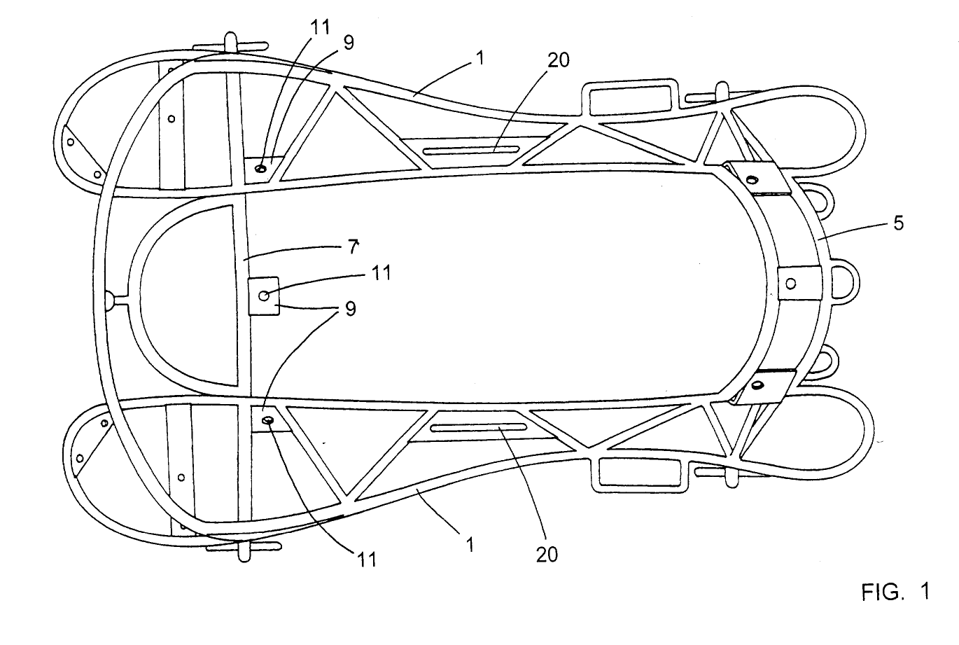

FIG. 2 is a perspective view of the tree in FIG. 1.

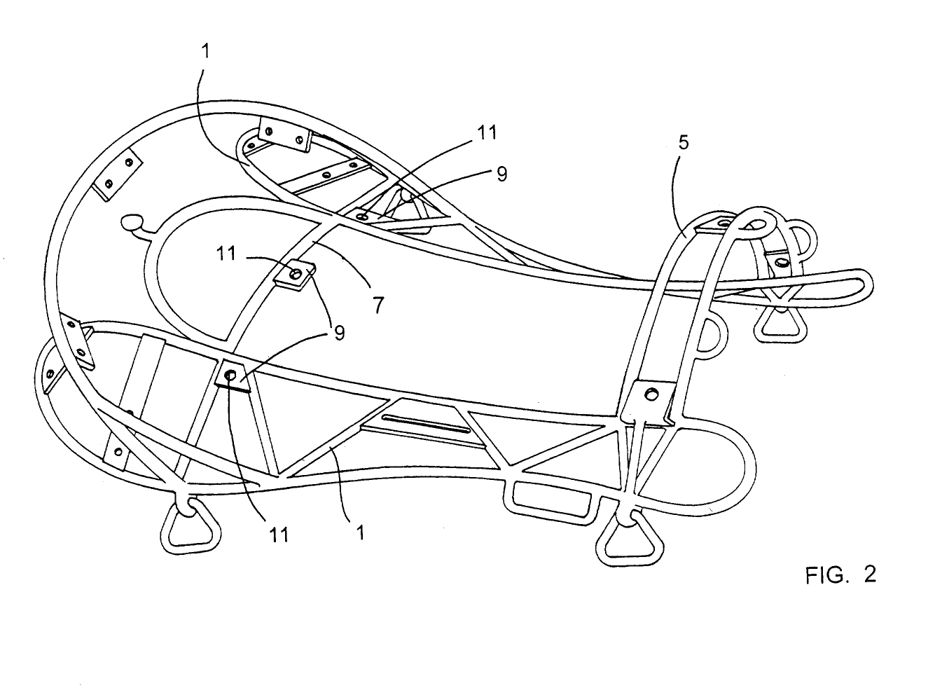

FIG. 3 is a perspective view of a tree with its corresponding pads.

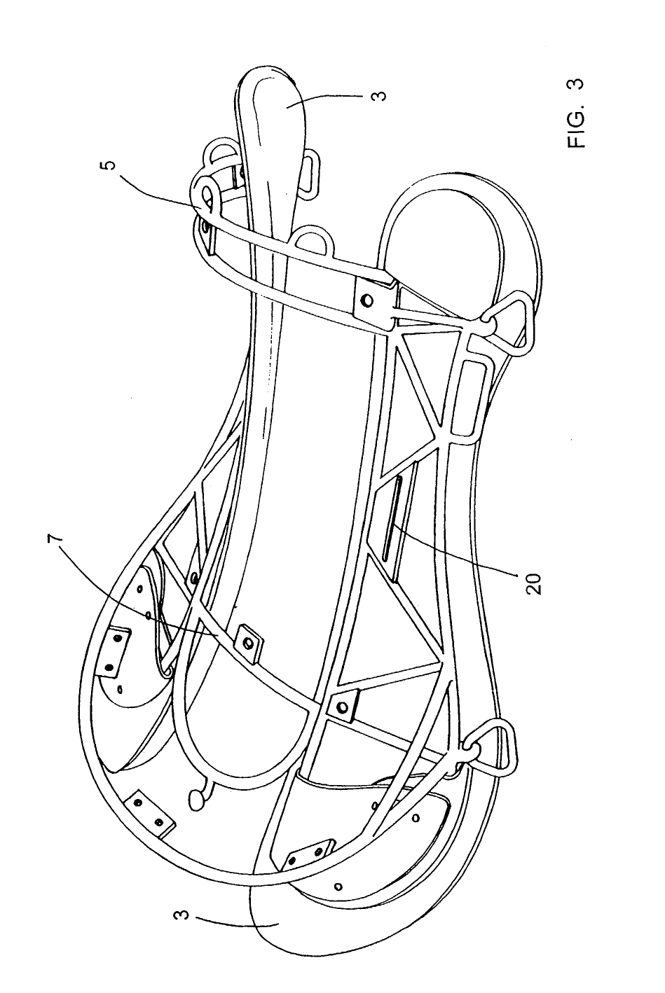

FIG. 4 is a perspective view of an anatomical platform according to the invention.

FIG. 5 is a plan view of a tree with the platform in FIG. 4.

FIG. 6 is a perspective view of the tree in FIG. 5.

FIG. 7 is a side elevation view of the tree in FIG. 5 with the platform covered by a single part according to the invention, and with the corresponding pads.

FIG. 8 is a perspective view of the tree in FIG. 7.

FIG. 9 is a longitudinal sectional view of the tree in FIG. 7, with a height adjustment device positioned at its lower level.

FIG. 10 is the view in FIG. 9, but with the height adjustment device positioned at its higher level.

### DETAILED DESCRIPTION OF SOME EMBODIMENTS OF THE INVENTION

The tree shown in the Figs. is made up of a structure of metal rods and comprises two warped bars 1 that are the same and symmetrical with respect to an intermediate plane that coincides substantially with the horse's spine, defining a longitudinal axis. A pad 3 is attached to each of the bars 1. The tree has a front bridge 5 and a rear bridge 7 which extend in a curved manner between both bars 1. Each bridge 5 and 7 is made up, in turn, of a series of metal rods. The tree has support plates 9 with threaded holes 11 which are part of height adjustment devices.

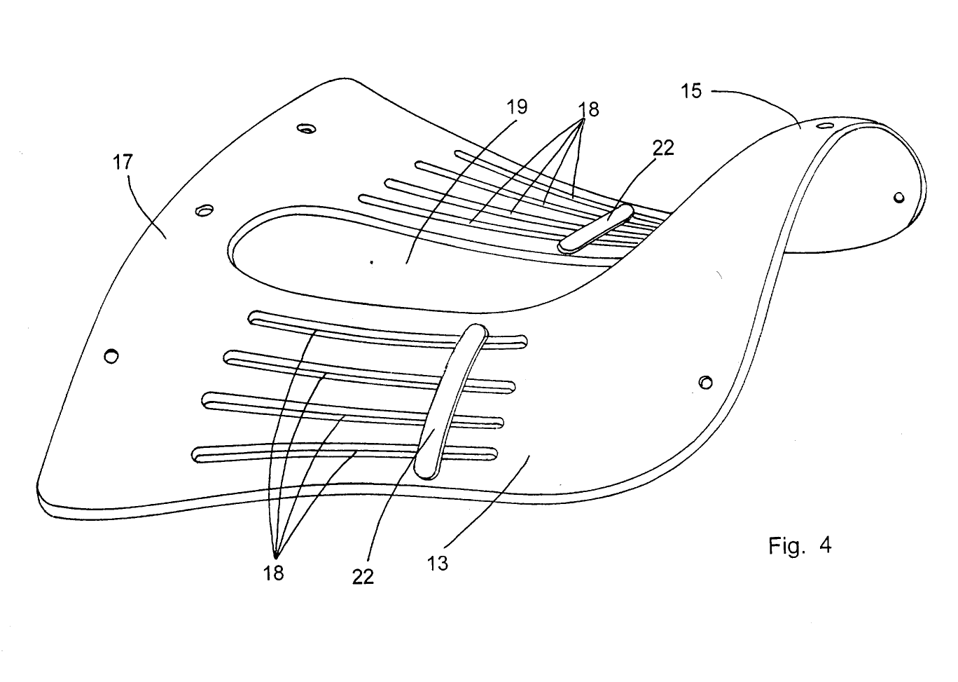

FIG. 4 shows a platform 13 according to the invention. Platform 13 has a front part 15 suitable for attaching to front bridge 5 and a rear part 17 suitable for attaching to rear bridge 7. In particular the attachment points of rear part 17 are three height adjustment devices.

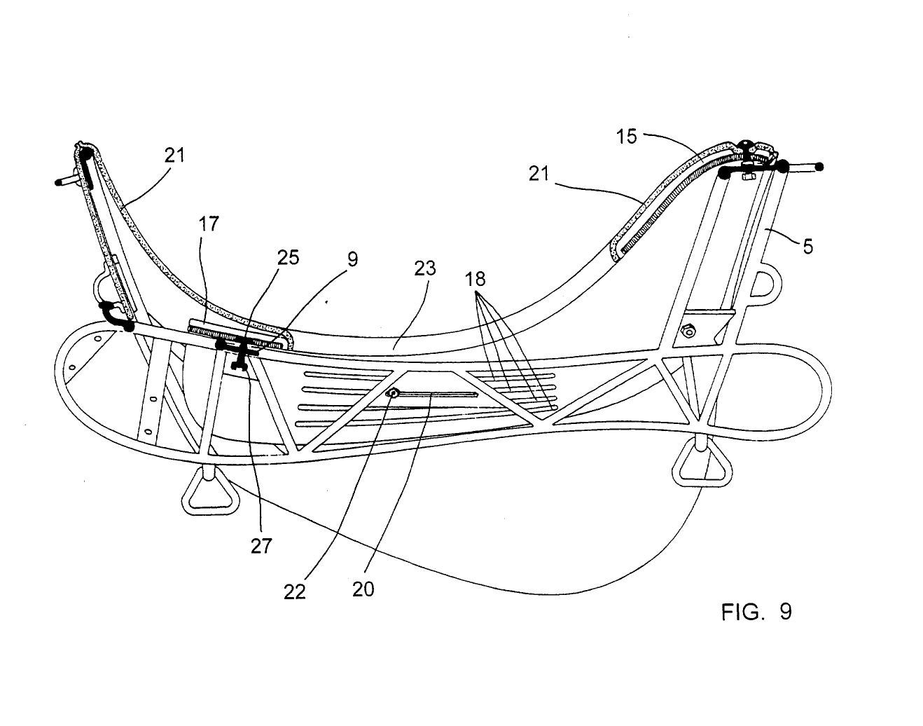

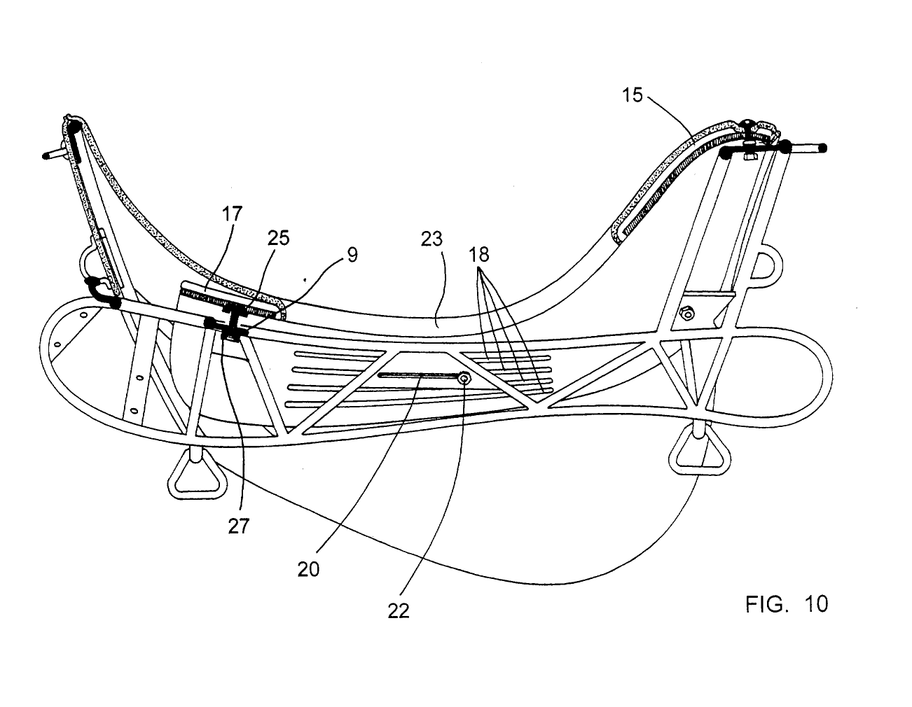

Platform 13 has first slots 18 arranged on the central part. When platform 13 is mounted on the tree, the first slots 18 are substantially facing second slots 20 arranged on the central part of the tree. Some attachment means 22 comprise screws provided with their corresponding nuts so that the screws can move along the first and second slots 18, 20 to the desired position. By tightening the nuts on the corresponding screws platform 13 is urged to deform so that the minimum height point of the top part of platform 13 can be adjusted according to the chosen position, as shown, for example, in FIGS. 9 and 10.

Platform 13 also has a hollow space 19 in the area corresponding to the rider's genitals.

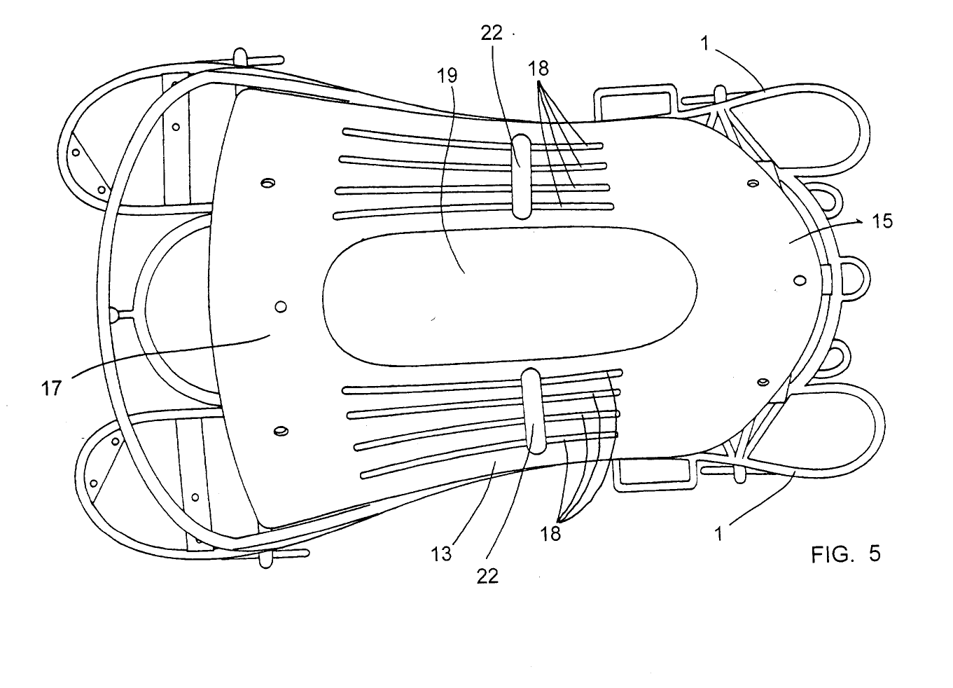

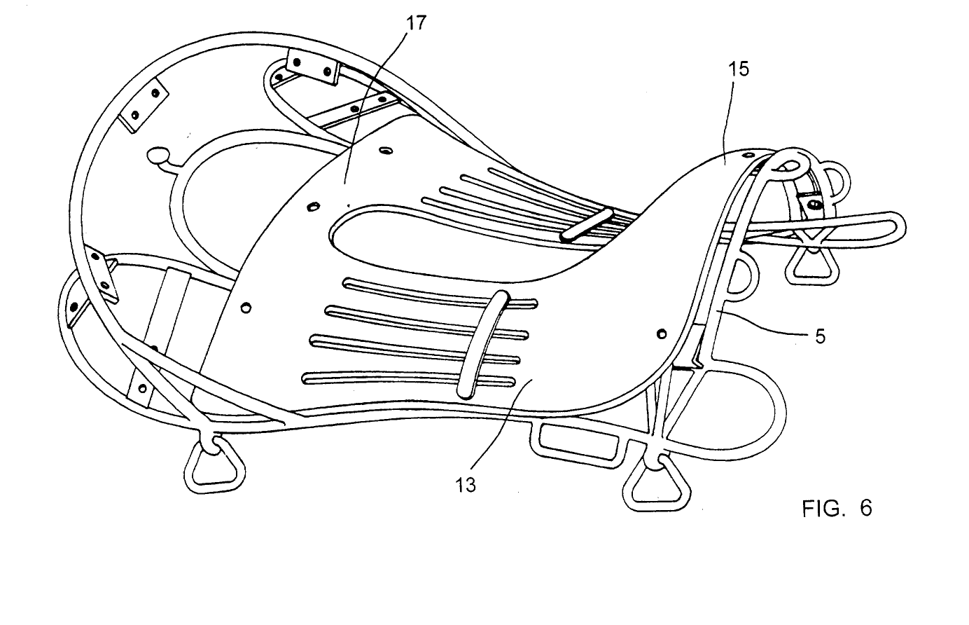

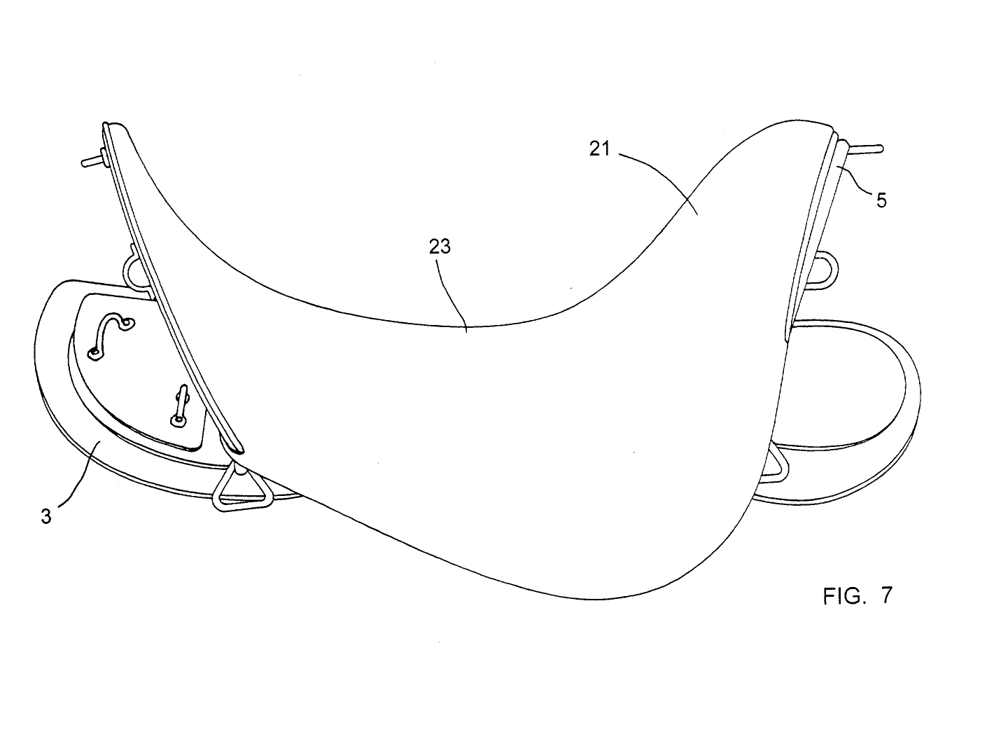

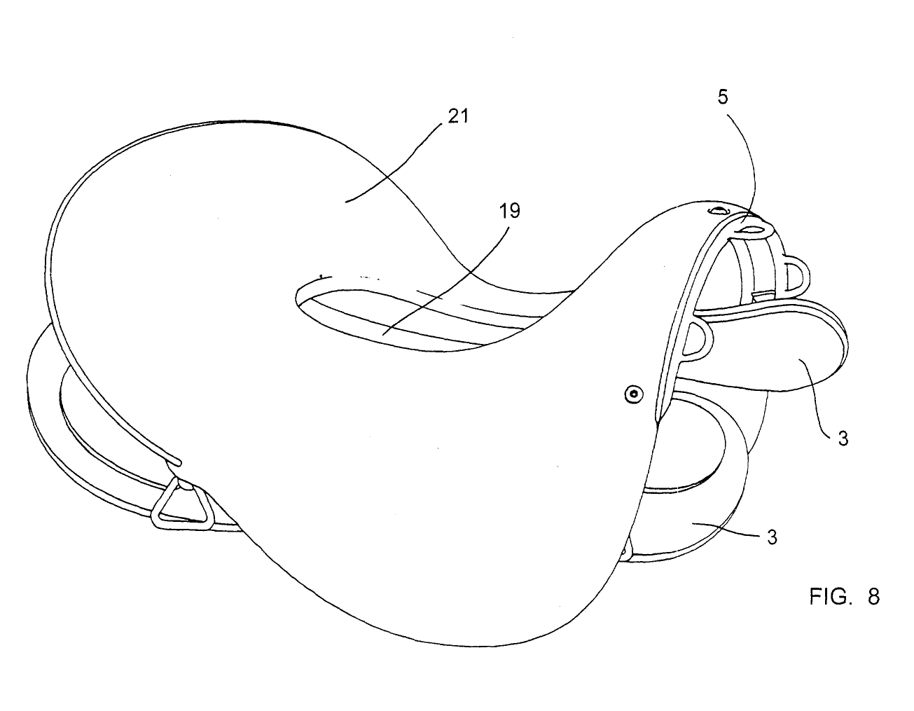

FIGS. 5 and 6 show the ensemble made up of the tree and platform 13, while FIGS. 7 and 8 show the ensemble made up of the tree, the two pads 3, platform 13 and a single part 21 that covers the top part of platform 13. Platform 13 and single part 21 substantially form the seat on which the riders sits. As shown, particularly in FIG. 7, the saddle according to the invention lets the rider sit at a much lower height with respect to the horse's back. Also it can be seen that the saddle's geometry is particularly suitable for varying, by means of the height adjustment device and the attachment means 22, the point where the rider sits. Effectively, by having a very flat intermediate section 23, a small variation in the height of rear part 17 of platform 13 varies relatively significantly the point where the rider sits. In this way, it is possible to influence the control that the rider has over the horse.

FIGS. 9 and 10 show a longitudinal section of the ensemble shown in FIG. 7. The height adjustment device, which comprises a screw 25 threaded in the threaded hole 11 foreseen on support plate 9, is arranged, in FIG. 9, in its lower position. Platform 13 rests against the head of screw 25 and single part 21 covers the top surface of platform 13. Screw 25 has on the free end thereof a nut or stop 27 which prevents it from falling and, possibly, enables screw 25 to be threaded without the need to access same from the top part. FIG. 10 shows how screw 25 is in a higher position, which urges platform 13 to deform in an upwards direction. Single part 21 can plastically absorb this deformation whereby its superficial finish continues to be smooth and ergonomic for the rider. By combining the effect of the screws 25 with the effect of the attachment means 22 described above, it is possible to adjust the rider's position with great accuracy, and in a simple way.

Platform 13 is preferably made from a plastics material preferably reinforced, such as for example kevlar or carbon fibre.

In the example shown in the Figs., there is only one second slot 20 on each side of the tree. Therefore, in this particular case only one of the slots 18 on each side of platform 13 will be facing the corresponding slot 20 on the tree and will be used for attachment by attachment means 22. The remaining slots 18 have a different purpose: by including these slots 18 it is possible to increase the flexibility of the central part of platform 13, which will mean it adapts more easily to the geometrical changes it undergoes.

1. Riding saddle ensemble, of the type comprising a metal tree, two pads (3) and a seat, where said tree is made up of a structure of metal rods and comprises: [a] two warped bars (1) that are the same and symmetrical with respect to an intermediate plane, where each of said pads (3) is attached to one of said bars and [b] a front bridge (5) and a rear bridge (7) which extend in a curved manner between both bars (1), characterised in that it comprises an anatomical platform (13), attached to said metal tree, where said platform (13) is rigid and is suitable for withstanding indefinitely the weight of a rider without becoming permanently deformed.

2. Riding saddle ensemble according to claim 1, characterised in that said anatomical platform (13) has a hollow space (19) in the area corresponding to the rider's genitals.

3. Riding saddle ensemble according to one of the claims 1 or 2, characterised in that it has at least one height adjustment device for at least one end of said seat.

4. Riding saddle ensemble according to claim 3, characterised in that said height adjustment device comprises a screw which passes through a first hole in said platform and a second hold in said tree, and a nut threaded on said screw and arranged between said first hole and said second hole.

5. Riding saddle ensemble according to claim 3, characterised in that said height adjustment device comprises a screw (25) threaded in a threaded hole (11) arranged on said tree, with said screw (25) resting on the lower surface of said platform (13).

6. Riding saddle ensemble according to at least one of the claims 1 to 5, characterised in that said platform (13) defines a top part which is the part that is in contact with the rider's body, and in that said platform (13) has said top part covered with a single part (21).

7. Riding saddle ensemble according to claim 6, characterised in that said single part (21) is appropriate for deforming plastically so that it is suitable for absorbing the geometrical changes caused by means of said height adjustment device.

8. Riding saddle ensemble according to one of the claims 6 or 7, characterised in that said single part (21) is leather.

9. Riding saddle ensemble according to at least one of the claims 1 to 8 where said platform (13) defines a top part which is the part that is in contact with the rider's body, characterised in that it comprises movable attachment means (22) that attach said platform (13) to said tree and that enable the point of minimum height of said top part to be moved.

10. Riding saddle ensemble according to claim 9, characterised in that said attachment means (22) attach said platform (13) to said tree through at least one first slot (18) arranged on said platform (13) and at least one second slot (20) arranged on said tree.

11. Use of a single piece of leather (21) to cover the whole of said top part of said platform (13) according to at least one of the claims 6 to 8.
